(19) United States
(12) Patent Application Publication
(10) Pub. No.: US 2026/0281106 A1
(43) Pub. Date: Sep. 17, 2026

(54) PROVIDING SECURITY WHILE CONNECTING PERIPHERAL DEVICES WHEN AN INFORMATION HANDLING SYSTEM IS IN A WORKING MODE

(71) Applicant: DELL PRODUCTS L.P., Round Rock, TX (US)

(72) Inventors: Parminder Singh Sethi, Ludhiana (IN); Avinash Kumar, Patna (IN); Anay Kishore, Bangalore (IN)

(21) Appl. No.: 19/081,599

(22) Filed: Mar. 17, 2025

(51) Int. Cl. H04L 9/40

(52) U.S. Cl. CPC H04L 63/0876; H04L 63/105

(57) ABSTRACT

An information handling system is configured to receive a request for a trust ranking of a peripheral device being connected to another information handling system and validate a signature associated with the peripheral device. The information handling system is also configured to determine a trust ranking of the peripheral device when the validation of the signature is successful. In addition, the information handling system is configured to generate a response to the request and transmit the response to the other information handling system.

### FIELD OF THE DISCLOSURE

The present disclosure generally relates to information handling systems, and more particularly relates to providing security when connecting peripheral devices while an information handling system is in a working mode.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system is configured to receive a request for a trust ranking of a peripheral device being connected to another information handling system and validate a signature associated with the peripheral device. The information handling system is also configured to determine a trust ranking of the peripheral device when the validation of the signature is successful. In addition, the information handling system is configured to generate a response to the request and transmit the response to the other information handling system, wherein the response includes the trust ranking of the peripheral device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an environment for providing security when connecting peripheral devices while an information handling system is in a working mode, according to an embodiment of the present disclosure;

FIG. 2 is a block diagram of a data center for providing security when connecting peripheral devices while an information handling system is in a working mode, according to an embodiment of the present disclosure;

FIGS. 3 and 4 are flowcharts of methods for providing security when connecting peripherals while an information handling system is in a working mode, according to an embodiment of the present disclosure; and

FIG. 5 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

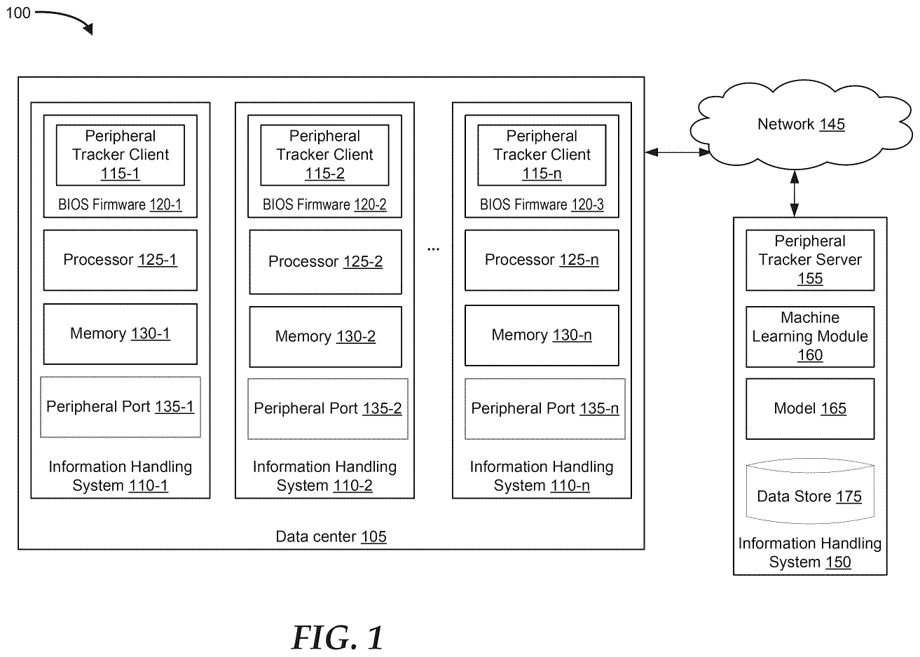

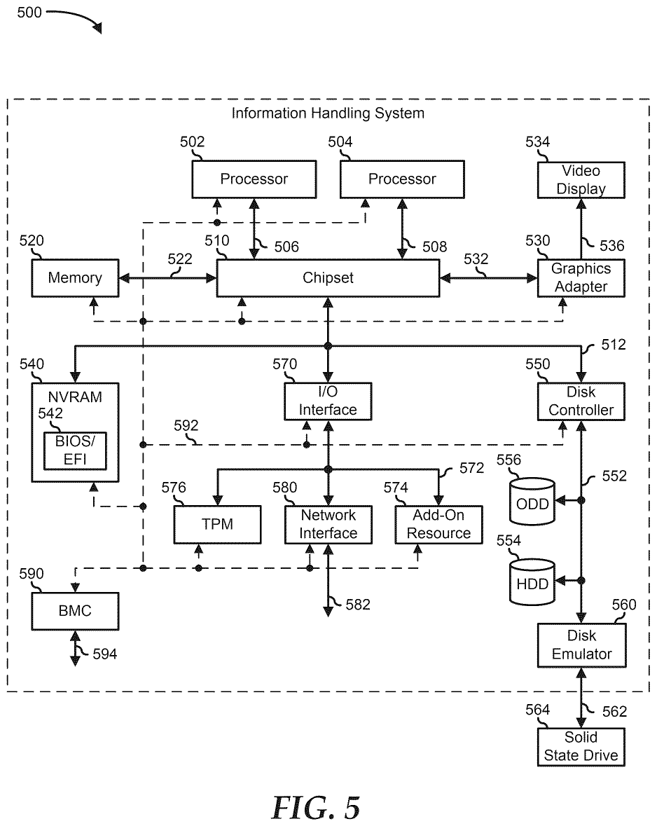

FIG. 1 illustrates a portion of an environment 100 for providing security when connecting peripheral devices while an information handling system is in a working mode, according to an embodiment of the present disclosure. Environment 100 includes a data center 105, a network 145, and an information handling system 150. Data center 105 includes information handling systems 110-1 through 110-n, which may be similar to information handling system 500 of FIG. 5. Information handling system 110-1 includes a basic input/output system (BIOS) firmware 120-1, a processor 125-1, a memory 130-1, and a peripheral port 135-1. BIOS firmware 120-1 may be coupled to processor 125-1 which may be coupled to memory 130-1, and peripheral port 135-1. However, any variety of connections between components of information handling system 110-1 is envisioned as falling within the scope of the present disclosure. In addition, connections between components may be omitted for descriptive clarity. Information handling systems 110-2 through 110-n include components and connections between components that are similar to information handling system 110-1.

BIOS firmware 120, which is similar to a basic input and output system/extensible firmware interface (BIOS/EFI) module 542 of FIG. 5, includes a peripheral tracker client 115. Peripheral tracker client 115 may be configured to detect physical presence of a peripheral device, such as when an external hardware peripheral or device is inserted or being connected to peripheral port 135. Processor 125, which may be similar to processors 502 and 504 of FIG. 5, may be configured to perform or execute operations of peripheral tracker client 115 among other firmware, software, applications, or similar. Memory 130 is similar to memory 520 of FIG. 5. Peripheral port 135 may be any port or interface where a peripheral device can be connected.

A data center, similar to data center 105 may be a facility to house a group of networked information handling systems typically used by organizations for the remote storage, processing, or distribution of large amounts of data, and includes associated components, such as servers, telecommunication systems, storage systems, power supplies, environmental controls, and security infrastructure. During the course of business transactions in the data center, there may be a need to perform several operations for uninterrupted output from an inline hardware and software stack. These operations may include tasks like maintaining the latest versions of firmware, drivers, and supportability tools, which may be performed either for the devices directly connected to the production environment or on devices supporting deployments and operational procedures. For such operations, external peripherals, and devices, such as pen drives, compact disk drives, and devices running certain services related to network or storage, among others may be connected to information handling systems similar to information handling systems 110. These devices get connected either directly to the information handling system's ports or through an additional port created by an add-on networking, storage, and peripheral component interconnect express (PCIe) card. The peripherals and/or devices referred to herein may simply be referred to as peripheral devices or peripherals,

Due to security concerns, care should be taken when connecting these untrusted peripheral devices, also referred to as foreign peripheral devices to the information handling system. For example, these foreign peripheral devices may contain a Trojan application or virus, which a user may or may not be aware of. There could also be a user with malicious intent when connecting foreign peripheral devices to the information handling system. If the organization does not have appropriate rules in place, the aforementioned action of the user with malicious intent could be detrimental. Even if the organization has strict parameters and stringent methods in place, there are chances that undesirable security acts may occur. However, the stringent methods sometimes can be repetitive, which can create bad a user experience and result in productivity loss.

Because a data center typically uses external peripherals and/or devices, these peripherals and/or devices are generally an inseparable part of a working data center. However, having peripherals and/or devices generally poses security challenges for the data center. This is because it is difficult to identify trusted external peripherals and/or devices from foreign external peripherals and/or devices, which can cause failures in critical business activities by introducing a virus or malware to the data center. In addition, unauthorized access of such foreign peripherals or foreign external devices can cause security risks related to data integrity, availability, and stability of the data in the data center. Further, these foreign external peripheral devices can introduce network or application vulnerabilities which can cause issues that are detrimental to company and customer data confidentiality. Such issues may trigger additional issues related to compliance, legal, and regulatory concerns.

Challenges related to managing and/or controlling the peripherals and external devices include having a centralized mechanism to deal with a large number of peripherals and devices and being able to differentiate, identify, and stop access of foreign devices and peripherals to protect the data center operations. Another challenge is to derive learning on trusted peripherals and external devices and ease their access for improved user experience and productivity. To address these and other concerns, the present disclosure provides a system and method to ensure a high level of security while figuring out the behavior pattern of the peripheral and/or device and establishing the trustworthiness of the peripheral device while improving a user's experience and curbing productivity loss. As such, the present disclosure provides a system and method that can implement a zero-trust policy by blocking any type of foreign or untrusted peripheral devices at a firmware level from automatically connecting and gaining default access or control of an information handling system, by utilizing system-level or operating system level interrupts and tapping into sensor information's to detect connection of a peripheral device.

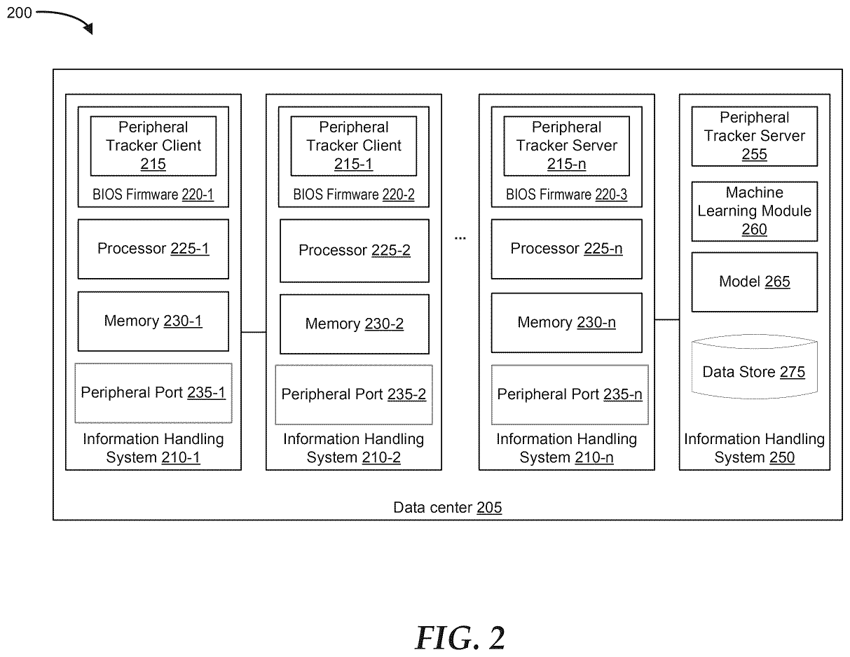

In particular, the present disclosure includes a two-tiered solution to achieve high-grade security with respect to external hardware peripherals and/or devices in a data center. First, a peripheral tracker server may be deployed within the data center or a cloud accessible to the data center via a network. In particular, the peripheral tracker server may be deployed in a remote server, on-premises server, virtual machine, container, or another type of virtualization infrastructure. In this example, a peripheral tracker server is deployed in an information handling system 150 remotely at a cloud, which is accessible by information handling systems 110 via network 145. In another example, a peripheral tracker server is deployed at an information handling system within the data center, as shown in FIG. 2.

The peripheral tracker server, such as peripheral tracker server 155, may be configured to track peripherals and other external devices in a data center. The peripheral tracker server can be based on the zero trust architecture and perform behavior ranking of the peripherals in a data center. The peripheral tracker server may be configured as a data center-based monitoring tool that may keep track and monitor the external peripherals and devices in the data center. The peripheral tracker server may be a smart and concept-level application, which can be plugged in with existing data center monitoring tools. In one embodiment, an information handling system in the data center that detects connection of a peripheral device may extend a query-based operation to peripheral tracker server 155. One of skill in the art will appreciate that peripheral tracker server 155 may receive queries or requests from information handling systems in other data centers associated with environment 100.

When a trusted or untrusted peripheral device is being connected to an information handling system 110 in data center 105, a query may be generated by peripheral tracker client 115 and transmitted to peripheral tracker server 155. The query may include information associated with the peripheral device, such as a signature of the peripheral device and other metadata. Peripheral tracker server 155 may capture the signature and metadata of the peripheral device, among other information from the received query. Peripheral tracker server 155 may process the captured information to provide guidance in the form of a response to the query, wherein the response may include data that information handling system 110 or peripheral tracker client 115 can use to take one or more further actions. For example, the guidance may include an indication to perform additional verification of the peripheral device.

Second, a peripheral tracker client may be a lightweight utility included in a server device firmware. In this example, peripheral tracker client 115 is included in BIOS firmware 120 and can be activated or enabled as an optional configuration. When peripheral tracker client 115 is enabled, it may be registered with peripheral tracker server 155. Peripheral tracker client 115 may interact with different firmware modules of information handling system 110 and collect information associated with the different firmware modules. For example, peripheral tracker client 115 may collect information associated with peripheral port 135. Based on this information, peripheral tracker client 115 may maintain a list of ports, such as peripheral port 135 where additional peripheral devices can be attached to information handling system 110. The list of ports may include universal serial bus (USB) and serial ports, network/storage ports, add-on card/PCIe ports, etc. Based on this information it may generate a logical mask to block or unblock these ports and work with peripheral tracker server 155 in case a peripheral is attached to any of the ports. Based on the response provided by peripheral tracker server 155, peripheral tracker client 115 may make an informed decision to take the process forward and allow/deny further access to the peripheral device.

The combination of peripheral tracker client 115 and peripheral tracker server 155 may provide a robust mechanism for the security and integrity of peripheral device operations in data center 105. Peripheral tracker client 115 and peripheral tracker server 155 may communicate with each other on a secure connection protocol, such as remote procedure call (RPC), general purpose RPC (gRPC), representational state transfer (REST), or similar.

Peripheral tracker server 155 may be centrally deployed in the customer environment on-premises at data center 105 or remotely in the cloud, such as at information handling system 150, and will be reachable via a query-based communication initiated by information handling systems 110 in data center 105. Peripheral tracker server 155 can be deployed in the customer network as one instance per data center or on a cloud-based architecture to ensure uninterrupted availability of its services to the peripheral tracker clients from one or more data centers communicating with it. In addition, peripheral tracker server 155 may be configured to maintain a history of the peripheral devices used or attached to an information handling system in a data center in environment 100. Further, peripheral tracker server 155 may derive behavior patterns for these peripherals whether trusted or untrusted.

In addition, peripheral tracker server 155 may maintain a “trust ranking” for each of the peripheral devices. The trust ranking may include several categories, such as high, medium, low, or zero trust ranking. Peripheral tracker server 155 may periodically update the trust ranking based on different parameters like usage patterns, historical authentication results summary, safe usage, alerts history, etc. This trust ranking may be used when deciding whether to ease the level of access control to the peripheral devices. The trust ranking may be maintained by peripheral tracker server 155 using a table, list, file, or any other data structure in data store 175. Further, peripheral tracker server 155 may monitor changes in the device firmware version of the peripherals, as the changing firmware may introduce new unknown vulnerabilities.

Various inputs associated with the peripherals from peripheral tracker server 155, which include history data, trust ranking, and device firmware version, among others, may be used by peripheral tracker clients to make informed decisions on whether to allow or deny access and perceive a level of trust that can be shown to the peripheral device. Peripheral tracker server 155 may also expose a gRPC server to communicate securely with the peripheral tracker clients, such as based on protocol buffers. As stated above, peripheral tracker server 155 may maintain different types of trust rankings for the peripherals. Upon identification of these trusted peripheral devices, access can be provided with validations according to their trust ranking.

Peripheral devices that may be known to the peripheral tracker server 155 and are used frequently in a data center, such as data center 105 may be given a high trust ranking. These peripheral devices may be trusted peripheral devices in the data center and may be given leniency for additional validation. Accordingly, various parameters may be determined by the administrator on how stringent the additional validations are if any. For example, the administrator may elect to perform minimal validation on highly trusted peripheral devices to save time and increase productivity. In one example, a peripheral device may be highly trusted when it is connected daily to an information handling system in the data center without security issues for at least a month.

Peripheral devices that are already known to peripheral tracker server 155 but have few instances of failures may be given a medium trust ranking. The failures may include instances wherein the user has not fully followed security practices, such as safe eject, abrupt failures, etc. These peripheral devices can be given access with a little bit of extra validation, such as using two-factor authentication, or similar. Peripheral devices that are either not known to the system or have a history of a major previous failure, such as having a virus, elevated system resource utilization, etc. may be given a low trust ranking. Providing access to these types of peripheral devices may need additional validation like administrator approval, biometric validations, etc. The administrator may employ extra precautions while using or approving such devices, such as scanning the peripheral device for viruses and/or malware. Peripheral devices that are identified as major security risks or have a history of multiple authentication failures or attacks in the past may be given a zero trust ranking. These peripheral devices may have been put on a blocked list and may not be trusted.

The present disclosure may generate the trust ranking levels or categories using machine learning, such as by employing a discounted cumulative gain (DCG) model. The DCG model may be pre-trained to generate a level of trust that can be associated with a peripheral device. Several types of information may be used to train the DCG model, such as device logs, connectivity history, security risks, and known vulnerabilities, among others. Different types of peripheral device logs, such as device connectivity logs maintained at an operating system level may be used to identify different types of failures, risks, vulnerabilities, exploits, and threats. This data will be picked up from the telemetry data collection pool that a vendor collects from client systems. The connectivity history may include connection and communication history data associated with different peripheral device types will help to pre-train the DCG model. The known vulnerabilities include inferences drawn from various data, such as the vendor, and data knowledge lake with information associated with different types of known and perceived vulnerabilities associated with peripheral devices.

Based on these and other information the machine learning module 160 may train model 165 which may then use these inferences and learnings to generate trust rankings for different types of peripherals in real time for a customer environment, such as data center 105. As part of generating the trust rankings, the graded relevance and inference can be drawn for a given instance or occurrence of a discrete event or query on a pre-trained scale. Based on threat perceptions and previous learnings, peripheral tracker server 155 may generate different types of graded outputs for a given peripheral or foreign device, such as high, medium, low, and zero trust ranking levels or categories.

Peripheral tracker client 115 may be a lightweight utility included in an information handling system's base firmware, such as BIOS firmware 120. Peripheral tracker client 115 may be configured to keep track and monitor peripheral devices being attached to information handling system 110. Peripheral tracker client 115 may be an option configuration in a firmware management console of information handling system 110. Peripheral tracker client 115 can be pushed as part of a firmware upgrade version for the system's base firmware.

Upon configuration, peripheral tracker client 115 may scan the server hardware and identify parts with internal or motherboard-based components and ports and/or interfaces where peripheral devices can be attached. Peripheral tracker client 115 may provide a zero-trust based cover to all such ports and/or interfaces. Sensors that may be related to ports and interfaces may be tied to a device-level interrupt signal whenever a new system file gets created or a peripheral device is detected, such as when the peripheral device is inserted or connected to the peripheral port or interface. The interrupt signal may inform peripheral tracker client 115 that a peripheral device is detected at peripheral port 135. The device level interrupt may trigger peripheral tracker client 115 which may actively block the connection of the peripheral device to the port or interface for further validation. Peripheral tracker client 115 may capture metadata and calculate a signature of the detected peripheral device that is being inserted in peripheral port 135 of information handling system 110. Peripheral tracker client 115 may transmit a query to peripheral tracker server 155 with information or details associated with the detected peripheral device and/or information handling system 110 over a gRPC secure trust tunnel.

Peripheral tracker server 155 may be configured to perform a behavior pattern study to compare a current trust ranking of the peripheral device and provide input to peripheral tracker client 115 on what access if any to provide the peripheral device. This input may help peripheral tracker client 115 in deciding the level of trust to be shown to the peripheral device. If the trust ranking for the peripheral device comes back as zero, the peripheral device may be rejected access, even if a user wants to allow access from an operating system level. Peripheral tracker client 115 may trigger security notifications for such incidents. A change in a peripheral device's firmware typically alters the signature of the peripheral device. Accordingly, the peripheral device may be treated as a new peripheral device. The monitoring of changes in the device firmware version is performed by peripheral tracker server 155 because changing the device firmware may introduce new unknown vulnerabilities and exploits.

Metadata information of a peripheral device may include a device name with model name or number along with manufacturer details. The metadata may also include a device type, such as whether the peripheral device is a printer, data storage, network device, etc. In addition, metadata may include a device identifier, serial number, vendor identifier, product identifier, interface type or class, driver information with version, firmware information with version, device size or speed, device or connection status, and additional capabilities if any.

Peripheral tracker client 115 may calculate a signature of the peripheral device based on one or more information in the metadata. The signature may be used to uniquely identify the peripheral device. In one embodiment, the collected set of metadata may be provided as input to a cryptographic algorithm, such as secure hash algorithm (SHA)-256, SHA-512, or similar to generate a unique but consistent identifier for the device. A benefit of using a cryptographic algorithm is that it will always generate the same identifier for the same set of inputs. Peripheral tracker client 115 may include the calculated signature in a query for a trust ranking and other information associated with the peripheral device, wherein the query is transmitted to peripheral tracker server 155. A deviation in the input may change the calculated signature, which may lead peripheral tracker server 155 to perceive the detected peripheral device as a new peripheral device, which is part of a zero-trust mechanism. Peripheral tracker server 155 may use the signature to determine trust ranking. If the detected peripheral device is deemed as a new peripheral device by peripheral tracker server 155, then calculate and perform an analysis to determine the trust ranking, which may be stored and mapped to the signature.

Network 145 may be configured to allow communication between information handling systems 110 through 110 and information handling system 150. Non-limiting examples of network 145 include a local area network, a wide area network, the Internet, a mobile network, a combination thereof, or any other type of network that allows for communication of data and sharing of resources among resources operatively connected to network 145.

Memory 130 may store computer instructions which, when executed by processors 125 cause information handling systems 110 to perform one or more processes specified in the computer instructions. Non-limiting examples of information handling systems 110 and information handling system 150 include a general-purpose computer, a network device, a server, a controller, and/or other types of computing devices with the aforementioned capabilities. The general-purpose computer can be a personal computer, desktop, laptop, tablet, smartphone, etc. The server can be a blade server in a blade server chassis, a rack server in a rack, etc.

Peripheral ports 135 may be external physical interfaces, such as USB ports, recommended standard serial ports, audio/visual ports, input/output ports, etc., wherein a hardware external peripheral device may be connected. Machine learning module 160 may be any system that includes a machine learning algorithm that is trained and tested with a modeling dataset generated from the environment's peripheral devices and their historical data. For example, the historical data used to generate the modeling dataset may be collected, transmitted, and stored at data store 175 of information handling system 150. Model 165 may be a machine learning model pre-trained to apply DCG measures to apply trust rankings to peripheral devices.

Data store 175 may be any system, device, or apparatus that is configured to store one or more data structures and/or datasets, such as mapping tables, modeling datasets, metadata, or other information associated with peripheral devices that have been connected to a peripheral port of information handling systems 110. In one example, each peripheral device signature may be mapped to a trust ranking category. Each trust ranking category may be mapped to pre-defined additional validation. Data store 175 may be based on one or more data platforms such as relational databases, HADOOP™, etc. The data set may also be stored in various formats such as text files, extensible markup language (XML) files, comma-separated values (CSV) files, etc. Data store 175 may be in a persistent storage device such as a solid-state disk, hard disk drive, magnetic tape library, optical disk drive, magneto-optical disk drive, compact disk drive, compact disk array, disk array controller, and/or any computer-readable medium operable to store data.

The operations described herein as being performed by peripheral tracker client 115 may be performed or executed by processor 125. Similarly, a processor of information handling system 150 may perform any suitable operations to execute peripheral tracker server 155 and/or machine learning module 160. Those of ordinary skill in the art will appreciate that the configuration, hardware, and/or software components of environment 100 depicted in FIG. 1. may vary.

The illustrative components within environment 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

FIG. 2 illustrates a portion of an environment 200 for providing security when connecting peripherals while an information handling system is in a working mode, according to an embodiment of the present disclosure. In this embodiment, a peripheral tracker server is deployed in a data center instead of in the cloud, such as depicted in environment 100 of FIG. 1. Environment 200 includes a data center 205, which is similar to data center 105 of FIG. 1, further includes information handling systems 210-1 through 210-n, which is further similar to information handling systems 110-1 through 110-n of FIG. 1. Information handling system 210-1 includes a basic input/output system (BIOS) firmware 220-1, a processor 225-1, a memory 230-1, and a peripheral port 235-1. BIOS firmware 220-1 may be coupled to processor 225-1 which may be coupled to memory 230-1, and peripheral port 235-1. However, any variety of connections between components of information handling system 210-1 is envisioned as falling within the scope of the present disclosure. In addition, connections between components may be omitted for descriptive clarity. Information handling systems 210-2 through 210-n include components and/or connections between the components that are similar to information handling system 210-1.

BIOS firmware 220, which is similar to BIOS firmware 120 of FIG. 1, includes a peripheral tracker client 215. Peripheral tracker client 215, which is similar to peripheral tracker client 115 of FIG. 1, may be configured to perform operations of peripheral tracker client 115 of FIG. 1, such as to detect whether an external hardware peripheral device is inserted in peripheral port 235 and transmit a query to a peripheral tracker server. Processor 225, which may be similar to processor 125 of FIG. 1, may be configured to perform operations of processor 125 of FIG. 1, such as to perform or execute operations of peripheral tracker client 215 among other firmware, software, applications, or similar. Memory 230 is similar to memory 130 FIG. 1.

Information handling system 250, which is similar to information handling system 150 of FIG. 1, includes a peripheral tracker server 255, a machine learning module 260, a model 265, and a data store 275. Peripheral tracker server 255, which is similar to peripheral tracker server 155 of FIG. 1, may be configured to perform operations similar to peripheral tracker server 155 of FIG. 1. Machine learning module 260, model 265, and data store 275 are similar to machine learning module 160, model 165, and data store 175 of FIG. 1 respectively.

The operations described herein as being performed by peripheral tracker client 215 may be performed or executed by processor 225. Similarly, a processor of information handling system 250 may perform any suitable operations to execute peripheral tracker server 255 and/or machine learning module 260. Those of ordinary skill in the art will appreciate that the configuration, hardware, and/or software components of environment 100 depicted in FIG. 1, and environment 200 depicted in FIG. 2 may vary. In one embodiment, data center 205 may be included in environment 100 of FIG. 1.

The illustrative components within environment 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

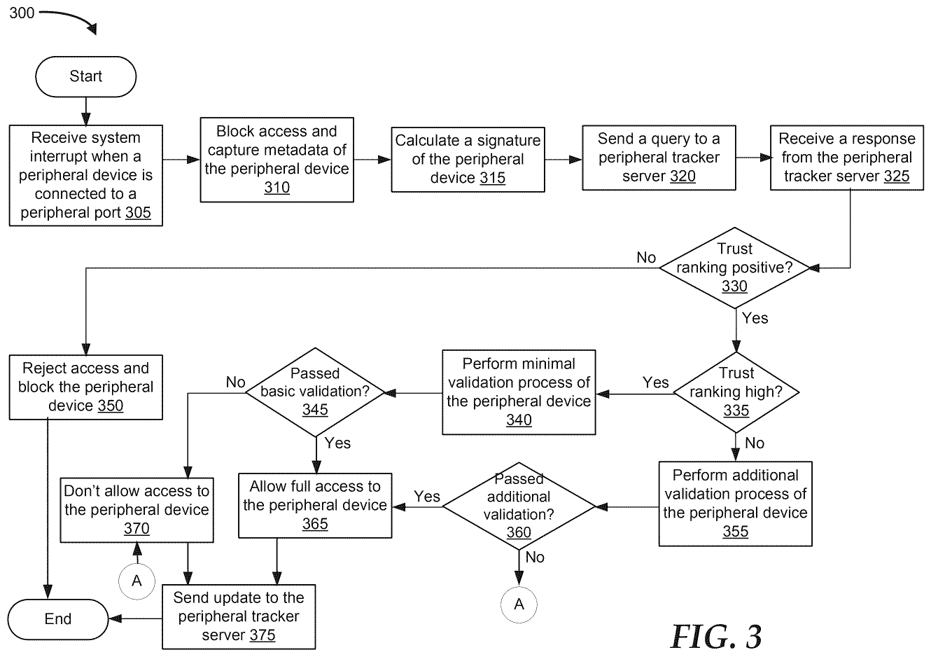

FIG. 3 illustrates a portion of a flowchart of a method 300 for providing security when connecting peripherals while an information handling system is in a working mode, according to an embodiment of the present disclosure. Method 300 may be performed by any suitable component of environment 100 including, but not limited to, peripheral tracker client 115 and peripheral tracker server 155 of FIG. 1. Method 300 may also be performed by any suitable component of data center 205 including, but not limited to, peripheral tracker client 215 and peripheral tracker server 255 of FIG. 2. While embodiments of the present disclosure are described in terms of the components of environment 100 of FIG. 1 and data center 205 of FIG. 2, it should be recognized that other components may be utilized to perform the described method. One of skill in the art will appreciate that this flowchart explains a typical example, which can be extended to applications or services in practice. Further, it will be readily appreciated that not every method step set forth in this flow diagram is always necessary and that certain steps of the methods may be combined, performed simultaneously, in a different order, or perhaps omitted, without varying from the scope of the disclosure.

Method 300 may be utilized to identify peripheral devices when connecting to an information handling system and generate a unique signature for each of the peripheral devices. For example, method 300 may identify whether a peripheral device is trusted or untrusted, also referred to as foreign peripheral devices. The signature helps a peripheral tracker server to identify the peripheral devices across a heterogeneous environment. When there is a change in metadata and/or other characteristics of the peripheral device, the signature may be changed or modified establishing a zero trust policy at the environment level instead of a peripheral device or system level. For example, when a firmware of a trusted peripheral device is upgraded, its signature may be changed which can lead the peripheral tracker server to deem the peripheral device as untrusted.

Method 300 typically starts at block 305 where a peripheral tracker client may receive a system interrupt indicating that a peripheral device is connected to a peripheral port of an information handling system in a data center. The method may proceed to block 310 where the peripheral tracker client may block access of the detected peripheral device to the information handling system. The peripheral tracker client may also capture metadata associated with the detected peripheral device. The method may proceed to block 315 where the peripheral client server may calculate a signature of the detected peripheral device. The signature may be used to authenticate the detected peripheral device.

After calculating the signature, at block 320, the peripheral tracker client may send a request or query for a trust ranking and/or associated recommendation for the detected peripheral device to a peripheral tracker server. The request or query may be transmitted via one or more data packets over a network. A packet header of a data packet may include a location and/or internet protocol address of the peripheral tracker server. A payload of the data packet may include the signature and the captured metadata.

The peripheral tracker server may be deployed in a cloud or another information handling system within the data center. In another embodiment, the peripheral tracker server may be deployed in the same information handling system as the peripheral tracker client. The query may include a signature among other information associated with the detected peripheral device. The query may also include information associated with the information handling system that the peripheral device is being connected to.

At block 325, the peripheral tracker client may receive a response from the peripheral tracker server. The response may include a trust ranking associated with the peripheral device. The trust ranking may be positive or negative, such as whether the peripheral device is trusted or untrusted. The trust ranking may be negative if the trust ranking is a category zero. The trust ranking includes other categories such as, high, medium, and low.

At decision block 330, the peripheral tracker server may determine a trust ranking of the detected peripheral or device. If the trust ranking is positive, then the “YES” branch is taken, and the method may proceed to decision block 335. If the trust ranking is not positive, then the “NO” branch is taken, and the method may proceed to block 350. At decision block 335, the peripheral tracker client may determine whether the trust ranking provided in the response is high. If the trust ranking is high, then the “YES” branch is taken, and the method may proceed to block 340. If the trust ranking is not high, then the “NO” branch is taken, and the method may proceed to block 355.

At block 340, the peripheral tracker client may perform a minimal validation process of the detected peripheral or device. For example, the peripheral tracker client may validate a certificate associated with the peripheral device. However, other forms of basic validation for peripheral devices with a high trust ranking may be performed as pre-determined by an administrator of the data center. The method may proceed to decision block 345 where the peripheral tracker client may determine whether the basic validation performed is successful. If the basic validation is successful, then the “YES” branch is taken, and the method may proceed to block 365. If the basic validation is not successful, then the “NO” branch is taken, and the method may proceed to block 370. At block 350, the peripheral tracker client may block and reject access to the information handling system of the peripheral or device. Afterwards, the method may end.

At block 355, the peripheral tracker client may perform additional validation processes, such as two-factor authentication, among others. At decision block 360, the peripheral tracker client may determine whether the additional validation process is successful. If the additional validation is successful, then the “YES” branch is taken, and the method may proceed to block 365. If the additional validation is not successful, then the “NO” branch is taken, and the method may proceed to block 370. At block 365, the peripheral tracker client may allow the detected peripheral device full access to the information handling system. The method may proceed to block 375. At block 370, the peripheral tracker server may not allow the detected peripheral device to access the information handling system. The method may proceed to block 375, where the peripheral tracker client may send an update to the peripheral tracker server. The update may include information associated with validation performed if any, whether the peripheral device passed the validation, and whether the peripheral device was allowed access to the information handling system or not. Afterwards, the method ends.

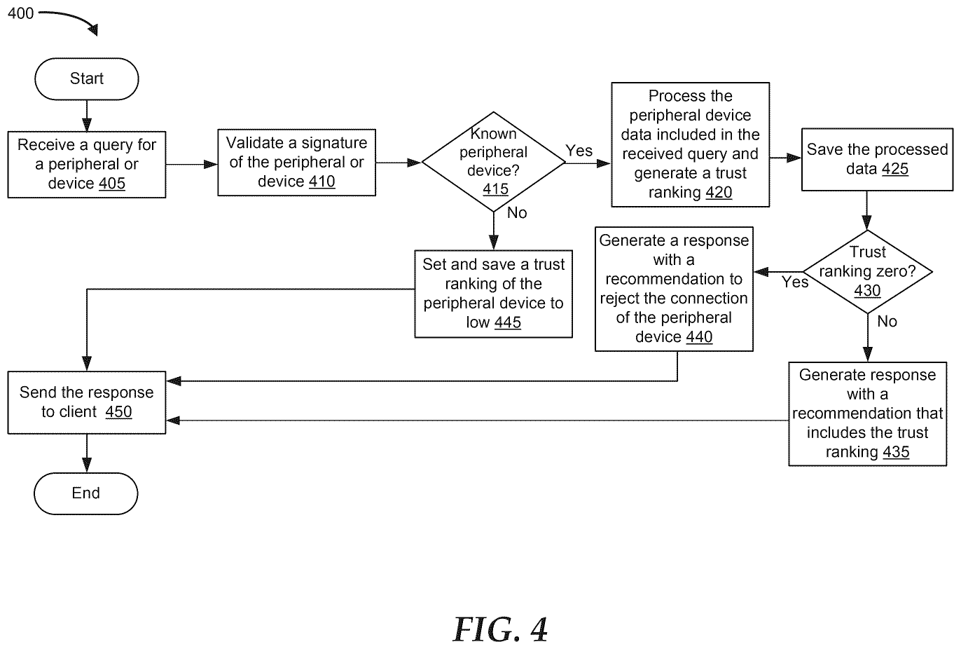

FIG. 4 illustrates a portion of a flowchart of a method 400 for providing security when connecting peripherals while an information handling system is in a working mode, according to an embodiment of the present disclosure. Method 400 may be performed by any suitable component of environment 100 including, but not limited to, peripheral tracker client 115 and peripheral tracker server 155 of FIG. 1. Method 400 may also be performed by any suitable component of data center 205 including, but not limited to, peripheral tracker client 215 and peripheral tracker server 255 of FIG. 2. While embodiments of the present disclosure are described in terms of the components of environment 100 of FIG. 1 and data center 205 of FIG. 2, it should be recognized that other components may be utilized to perform the described method. One of skill in the art will appreciate that this flowchart explains a typical example, which can be extended to applications or services in practice.

Method 400 may be utilized to drive a trust ranking of peripheral devices by applying a grading approach of the peripheral devices based on various information and/or historical data, such as device logs, connectivity history known vulnerabilities of similar peripheral devices, and applying a pre-trained DCG model. The connectivity history may be based on the unique signature of each peripheral device. Method 400 may also determine a recommendation that includes additional validations to be performed if any before the peripheral device is allowed access to the information handling system.

Method 400 typically starts at block 405, where a peripheral tracker server may receive a query for a trust ranking of a peripheral device, wherein the query is from a peripheral tracker client. The peripheral tracer client may send the query when it detects that a peripheral device is connected to or inserted into a peripheral port of an information handling system located in a data center. At block 410, the peripheral tracker server may validate the signature of the peripheral device. For example, the peripheral tracker server may compare the signature received in the request with signatures stored and managed by the peripheral tracker server to determine whether the signature of the peripheral device is among signatures stored and managed by the peripheral tracker server. In one embodiment, the peripheral tracker server may manage and control the stored signatures of the peripheral devices along with associated trust rankings. For example, the peripheral tracker server may maintain a table, a file, a database, or similar that includes mapping of peripheral device's signatures with trust rankings along with other information.

At decision block 415, the peripheral tracker server may determine whether the peripheral device is known. The peripheral device is known when its signature is one of the signatures stored and managed by the peripheral tracker server. The peripheral device is not known when its signature is not one of the signatures stored and managed by the peripheral tracker server. If the peripheral device is known, then the “YES” branch is taken, and the method may proceed to block 420. If the peripheral device is not known, then the “NO” branch is taken, and the method may proceed to block 445.

At block 4250, the peripheral tracker server may process the data associated with the peripheral device that is included in the query. For example, the peripheral tracker server may use the data as input for a machine learning module and associated model to determine a trust ranking for the peripheral device. The method may proceed to block 425, where the peripheral tracker server may save the processed data. For example, the peripheral tracker server may update the trust ranking associated with the signature of the peripheral device, such as in a mapping table, a database, or similar. This allows the peripheral tracker server to keep track of the peripheral devices that have been connected to an information handling system of a data center along with their trust rankings.

At decision block 430, the peripheral tracker server may determine whether the trust ranking of the peripheral device associated with the signature is zero. If the trust ranking is zero, then the “YES” branch is taken, and the method may proceed to block 440. If the trust ranking is not zero, then the “NO” branch is taken, and the method may proceed to block 435. At block 435, the peripheral tracker server may generate a response with a recommendation that includes the trust ranking of the peripheral device. The recommendation may include information on whether or not to perform additional validation prior to allowing the connection based on the trust ranking of the peripheral device. For example, the recommendation may be to perform an additional validation prior to allowing the peripheral device access to the information handling system. The method may proceed to block 450.

At block 440, the peripheral tracker server may generate a response with a recommendation to reject the connection of the peripheral device. The method may then proceed to block 450. At block 445, the peripheral tracker server may set the trust ranking of the peripheral device to low and save the trust ranking along with other information associated with the peripheral device. The peripheral tracker server may also determine a recommendation associated with the low trust ranking. The method may proceed to block 450 where the peripheral tracker server may send a response to the request or query from the peripheral tracker client. The response may be transmitted using an application programming interface via one or more data packets. A header of a data packet may include a location and/or internet protocol address of the information handling system hosting the peripheral tracker client that transmitted the request or query. A payload of the data packet may include the trust ranking and/or associate recommendation. Afterward, the method ends.

FIG. 5 illustrates an embodiment of an information handling system 500 including processors 502 and 504, a chipset 510, a memory 520, a graphics adapter 530 connected to a video display 534, a non-volatile RAM (NVRAM) 540 that includes a basic input and output system/extensible firmware interface (BIOS/EFI) module 542, a disk controller 550, a hard disk drive (HDD) 554, an optical disk drive 556, a disk emulator 560 connected to an SSD 564, an I/O interface 570 connected to an add-on resource 574 and a trusted platform module (TPM) 576, a network interface 580, and a baseboard management controller (BMC) 590. Processor 502 is connected to chipset 510 via processor interface 506, and processor 504 is connected to the chipset via processor interface 508. In a particular embodiment, processors 502 and 504 are connected together via a high-capacity coherent fabric, such as a HyperTransport link, a QuickPath Interconnect, or the like. Chipset 510 represents an integrated circuit or group of integrated circuits that manage the data flow between processors 502 and 504 and the other elements of information handling system 500. In a particular embodiment, chipset 510 represents a pair of integrated circuits, such as a northbridge component and a southbridge component. In another embodiment, some or all of the functions and features of chipset 510 are integrated with one or more of processors 502 and 504.

Memory 520 is connected to chipset 510 via a memory interface 522. An example of memory interface 522 includes a Double Data Rate (DDR) memory channel and memory 520 represents one or more DDR Dual In-Line Memory Modules (DIMMs). In a particular embodiment, memory interface 522 represents two or more DDR channels. In another embodiment, one or more of processors 502 and 504 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 520 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 530 is connected to chipset 510 via a graphics interface 532 and provides a video display output 536 to a video display 534. An example of a graphics interface 532 includes a Peripheral Component Interconnect-Express (PCIe) interface and graphics adapter 530 can include a four-lane (x4) PCIe adapter, an eight-lane (x8) PCIe adapter, a 16-lane (x16) PCIe adapter, or another configuration, as needed or desired. In a particular embodiment, graphics adapter 530 is provided down on a system printed circuit board (PCB). Video display output 536 can include a Digital Video Interface (DVI), a High-Definition Multimedia Interface (HDMI), a DisplayPort interface, or the like, and video display 534 can include a monitor, a smart television, an embedded display such as a laptop computer display, or the like.

NVRAM 540, disk controller 550, and I/O interface 570 are connected to chipset 510 via an I/O channel 512. An example of I/O channel 512 includes one or more point-to-point PCIe links between chipset 510 and each of NVRAM 540, disk controller 550, and I/O interface 570. Chipset 510 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a USB, another interface, or a combination thereof. NVRAM 540 includes BIOS/EFI module 542 that stores machine-executable code (BIOS/EFI code) that operates to detect the resources of information handling system 500, to provide drivers for the resources, to initialize the resources, and to provide common access mechanisms for the resources. The functions and features of BIOS/EFI module 542 will be further described below.

Disk controller 550 includes a disk interface 552 that connects the disc controller to an HDD 554, to an optical disk drive (ODD) 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an institute of electrical and electronics engineers (IEEE) 1394 (Firewire) interface, a proprietary interface, or a combination thereof. Alternatively, SSD 564 can be disposed within information handling system 500.

I/O interface 570 includes a peripheral interface 572 that connects the I/O interface to add-on resource 574, to TPM 576, and to network interface 580. Peripheral interface 572 can be the same type of interface as I/O channel 512 or can be a different type of interface. As such, I/O interface 570 extends the capacity of I/O channel 512 when peripheral interface 572 and the I/O channel are of the same type, and the I/O interface translates information from a format suitable to the I/O channel to a format suitable to the peripheral interface 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board, or add-in card disposed within information handling system 500, a device that is external to the information handling system, or a combination thereof.

Network interface 580 represents a network communication device disposed within information handling system 500, on a main circuit board of the information handling system, integrated onto another component such as chipset 510, in another suitable location, or a combination thereof. Network interface 580 includes a network channel 582 that provides an interface to devices that are external to information handling system 500. In a particular embodiment, network channel 582 is of a different type than peripheral interface 572 and network interface 580 translates information from a format suitable to the peripheral channel to a format suitable to external devices.

In a particular embodiment, network interface 580 includes a NIC or host bus adapter (HBA), and an example of network channel 582 includes an InfiniBand channel, a Fibre Channel, a Gigabit Ethernet channel, a proprietary channel architecture, or a combination thereof. In another embodiment, network interface 580 includes a wireless communication interface, and network channel 582 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 582 can be connected to an external network resource (not illustrated). The network resource can include another information handling system, a data storage system, another network, a grid management system, another suitable resource, or a combination thereof.

BMC 590 is connected to multiple elements of information handling system 500 via one or more management interface 592 to provide out-of-band monitoring, maintenance, and control of the elements of the information handling system. As such, BMC 590 represents a processing device different from processor 502 and processor 504, which provides various management functions for information handling system 500. For example, BMC 590 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 590 can vary considerably based on the type of information handling system. BMC 590 can operate in accordance with an Intelligent Platform Management Interface (IPMI). Examples of BMC 590 include an Integrated Dell® Remote Access Controller (iDRAC).

Management interface 592 represents one or more out-of-band communication interfaces between BMC 590 and the elements of information handling system 500 and can include an Inter-Integrated Circuit (I²C) bus, a System Management Bus (SMBUS), a Power Management Bus (PMBUS), a Low Pin Count (LPC) interface, a serial bus such as a USB or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 500, that is apart from the execution of code by processors 502 and 504 and procedures that are implemented on the information handling system in response to the executed code.

BMC 590 operates to monitor and maintain system firmware, such as code stored in BIOS/EFI module 542, option ROMs for graphics adapter 530, disk controller 550, add-on resource 574, network interface 580, or other elements of information handling system 500, as needed or desired. In particular, BMC 590 includes a network interface 594 that can be connected to a remote management system to receive firmware updates, as needed or desired. Here, BMC 590 receives the firmware updates, stores the updates to a data storage device associated with the BMC, and transfers the firmware updates to NVRAM of the device or system that is the subject of the firmware update, thereby replacing the currently operating firmware associated with the device or system, and reboots information handling system, whereupon the device or system utilizes the updated firmware image.

BMC 590 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 590, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 590 is included on a main circuit board (such as a baseboard, a motherboard, or any combination thereof) of information handling system 500 or is integrated into another element of the information handling system such as chipset 510, or another suitable element, as needed or desired. As such, BMC 590 can be part of an integrated circuit or a chipset within information handling system 500. An example of BMC 590 includes an iDRAC, or the like. BMC 590 may operate on a separate power plane from other resources in information handling system 500. Thus BMC 590 can communicate with the management system via network interface 594 while the resources of information handling system 500 are powered off. Here, information can be sent from the management system to BMC 590 and the information can be stored in a RAM or NVRAM associated with the BMC. Information stored in the RAM may be lost after power-down of the power plane for BMC 590, while information stored in the NVRAM may be saved through a power-down/power-up cycle of the power plane for the BMC.

Information handling system 500 can include additional components and additional busses, not shown for clarity. For example, information handling system 500 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 500 can include multiple central processing units (CPUs) and redundant bus controllers. One or more components can be integrated together. Information handling system 500 can include additional buses and bus protocols, for example, I²C and the like. Additional components of information handling system 500 can include one or more storage devices that can store machine-executable code, one or more communications ports for communicating with external devices, and various input and output (I/O) devices, such as a keyboard, a mouse, and a video display.

For purposes of this disclosure, information handling system 500 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 500 can include processing resources for executing machine-executable code, such as processor 502, a programmable logic array (PLA), an embedded device such as a System-on-a-Chip (SoC), or other control logic hardware. Information handling system 500 can also include one or more computer-readable media for storing machine-executable code, such as software or data.

As used herein, a hyphenated form of a reference numeral refers to a specific instance of an element and the un-hyphenated form of the reference numeral refers to the collective or generic element. Thus, for example, peripheral tracker client 115-1 refers to an instance of a peripheral tracker client class, which may be referred to collectively as peripheral tracker clients 115 and any one of which may be referred to generically as a peripheral tracker client 115.

Although FIG. 3, and FIG. 4 show example blocks of method 300 and method 400 in some implementations, method 300 and method 400 may include additional blocks, fewer blocks, different blocks, or differently arranged blocks than those depicted in FIG. 3 and FIG. 4. Those skilled in the art will understand that the principles presented herein may be implemented in any suitably arranged processing system. Additionally, or alternatively, two or more of the blocks of method 300 and method 400 may be performed in parallel. For example, blocks 310 and 315 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a processor, a request for a trust ranking of a peripheral device being connected to an information handling system;
validating a signature associated with the peripheral device;
when the validating of the signature is successful, then determining a trust ranking of the peripheral device;
generating a response to the request, wherein the response includes the trust ranking of the peripheral device; and
transmitting the response to the information handling system.

2. The method of claim 1, wherein the request includes the signature of the peripheral device.

3. The method of claim 1, further comprising setting the trust ranking of the peripheral device to low when the peripheral device is unknown.

4. The method of claim 1, wherein the request is transmitted by a peripheral tracking client deployed at the information handling system in response to detecting that the peripheral device is connecting to the information handling system.

5. The method of claim 1, wherein the response includes a recommendation on whether or not to perform additional validation.

6. The method of claim 1, wherein a peripheral tracking client blocks access of the peripheral device in response to a negative trust ranking.

7. The method of claim 1, wherein a peripheral tracking client performs additional validation in response to a positive trust ranking.

8. The method of claim 1, when the trust ranking is equal to zero, then providing a recommendation to reject a connection of the peripheral device.

9. An information handling system, comprising:
a processor; and
a memory coupled to the processor, the memory having program instructions stored thereon that upon execution cause the processor to:
receive a request for a trust ranking of a peripheral device being connected to another information handling system;
validate a signature associated with the peripheral device;
when the validation of the signature is successful, then determine a trust ranking of the peripheral device;
generate a response to the request, wherein the response includes the trust ranking of the peripheral device; and
transmit the response to the other information handling system.

10. The information handling system of claim 9, wherein the request includes the signature of the peripheral device.

11. The information handling system of claim 9, wherein the processor is further configured to set the trust ranking of the peripheral device to low when the peripheral device is unknown.

12. The information handling system of claim 9, wherein the request is transmitted by a peripheral tracking client deployed at the information handling system in response to detecting that the peripheral device is connecting to the other information handling system.

13. The information handling system of claim 9, wherein the response includes a recommendation on whether or not to perform additional validation.

14. A non-transitory computer-readable medium to store instructions that are executable to perform operations comprising:
receiving a request for a trust ranking of a peripheral device being connected to an information handling system;
validating a signature associated with the peripheral device;
when the validating of the signature is successful, then determining a trust ranking of the peripheral device;
generating a response to the request, wherein the response includes the trust ranking of the peripheral device; and
transmitting the response to the information handling system.

15. The non-transitory computer-readable medium of claim 14, wherein the request includes the signature of the peripheral device.

16. The non-transitory computer-readable medium of claim 14, wherein the operations further comprise setting the trust ranking of the peripheral device to low when the peripheral device is unknown.

17. The non-transitory computer-readable medium of claim 14, wherein the request is transmitted by a peripheral tracking client deployed at the information handling system in response to detecting that the peripheral device is connecting to the information handling system.

18. The non-transitory computer-readable medium of claim 14, wherein the response includes a recommendation on whether or not to perform additional validation.

19. The non-transitory computer-readable medium of claim 14, when the trust ranking is equal to zero, then providig a recommendation to reject a connection of the peripheral device.
